(19) United States
(12) Patent Application Publication
(10) Pub. No.: US 2007/0021046 A1
(43) Pub. Date: Jan. 25, 2007

(54) Downdraft fume hood

(75) Inventors: Rong Fung Huang, Taipei (TW); Yu-Kang Chen, Gueiren Township (TW); Tung-Sheng Shih, Shijr City (TW); Cheng-Plug Chang, Shijr City (TW); Chun-Wan Chen, Shijr City (TW); Yi-Ta Wu, Taipei City (TW); Hung-Ta Chen, Taipei City (TW)

Correspondence Address: TROXELL LAW OFFICE PLLC, SUITE 1404, 5205 LEESBURG PIKE, FALLS CHURCH, VA, 22041, US

(73) Assignee: Institute of Occupational Safety and Health, Council of Labor Affairs

(21) Appl. No.: 11/183,747

(22) Filed: Jul. 19, 2005

(51) Int. Cl. B08B 15/02

(52) U.S. Cl. 454/61

(57) ABSTRACT

The present invention is a fume hood with a mechanism of air suction together with air supply to save energy while locally exhausting pernicious gases near a contaminant source.

### FIELD OF THE INVENTION

The present invention relates to a fume hood; more particularly, relates to deposing an exhaust outlet at front bottom rim of the fume hood and a screen on top of the fume hood so that a mechanism of air suction together with air supply is obtained for air-exhausting near a contaminant source to save energy while exhausting pernicious gases, which can be applied in some processes of manufacturing semiconductors (such as photo resist etching, crystal furnace cleansing, etc.) or applied in a laboratory or a similar construction.

### DESCRIPTION OF THE RELATED ART(S)

A hood is a main part for a local exhauster, which mainly exhausts contaminant gases into a local exhausting pipe. To fit in with working environments, there are many types of hoods, such as the close type, the booth type, the by-pass type, the push-suction type, etc. Therein, the close-type hood has the best trapping effect while preventing influence from the outside environment. But the close-type hood is totally closed and so may do harms to the on-site workers. So, this kind of hood is used only in harmful or highly dangerous working environments. Instead, a booth-type hood is usually used in an environment required of higher protection, which contains close surfaces except a surface left to be opened to the outside. In general, its protection effect and trapping effect are better than those of the other non-close type hood; and its performance is not influenced by the outside environment.

The booth-type hoods are most often found as chemical fume hoods in laboratories. Some manufacturing processes in the semiconductor industry, such as photoresist etching, crystal furnace cleansing, etc., are run in chemical fume hoods. By the development of the biotechnology, laboratory biohazards have gained more and more attention. The biosafety cabinets used in microbiology laboratories area also basically a booth-type hood. In general, a booth-type hood is used in an environment with higher protection requirement and concept.

When comparing to a by-pass type hood, a general booth-type hood comprises a hood surrounding with an exhaust hole or suction slot; and, if in need, with baffles to distribute air evenly. A better booth-type hood may even depose a device for supplying air. Nevertheless, both of the chemical fume hood and the biosafety cabinet each has a sliding door to control the area of opening.

The ultimate goal for deposing a booth-type hood is to prevent the pernicious objects from escaping outside. Yet, in actual operations, pernicious objects may escape sometimes. The reasons may be concluded into three categories as follows:

1. Lacking most appropriate design such as being short in air suction, improperly positioning suction slot, inappropriately locating air supply, unevenly distributing air velocity at an opening, unfavorably designing edges at the opening, etc.;

2. Not operating under the best situation: such as too much pernicious objects released, inner pernicious objects rapidly escaping toward the opening, too big movement of operation from the inside to the outside, over wide-opened sliding door, air suction lack of examination when operating, etc. and

3. Maintaining improperly: such as breakage of the booth wall or the pipe, malfunction or disability of the exhausting device, etc.

Furthermore, besides preventing the pernicious objects from polluting environment and infecting people by escaping outside, in some industries, such as the semiconductor industry and the biotechnology industry, preventing samples in the hood from being polluted by the air outside has to be considered too. Thereby, the design and the function evaluation for the hood become harder.

A fume hood in Renaissance discharged harmful gas out of the room through a chimney by utilizing heat convection effect. At that time, the building technology of the chimney was not perfect until the development of computational fluid dynamics (CFD), which developed a technology of utilizing high altitude side-wind flow. By such a technology, a local low pressure is formed in the chimney to help carrying out the flow inside. The later fume hood was following the original chimney design except adding an exhaust fan to carry wind flow out with an enforced convection.

Conventional fume hoods use exhaust fans to carry harmful gas out, which can be divided into two categories, CAV (constant volume air volume) and VAV (variable volume air volume).

Please refer to FIG. 4 and FIG. 5, which are a front view and a cross-sectional view according to a prior art. As shown in the figures, a chemical fume hood has a fume hood 21, comprising a baffle 22 with a turning angle near the exhausting opening and three slots 23 on the baffle 22 to help exhausting air. At the bottom of the baffle 22 , a gap is located between the baffle 22 and the wall of the fume hood 21. The exhausting opening at the top of the fume hood 21 is connected with a Venturi tube to the outside through an air shaft of PP (Polypropylene) plastic. In the end, a blower 24 is used to exhaust air. The main purpose for the fume hood 21 is to exhaust the harmful output of a chemical reaction. So, before the reaction begins, the blower has to be turned on to blow air. At his time, the sash 25 should not be shut completely; or, the blower would be in idle running or even worn our when the sash 25 is shut completely without any mechanism of air supply. When an operator reaches his hand into the hood for an operation, the sash 25 is opened to a required height, where the harmful output in the hood does not escape outside even with the mechanism of the air exhausting in the hood. Yet, for the fume hood is not designed from a viewpoint of CFD to improve its structure and the flow fields inside, the flow fields inside the fume hood according to the prior art comprise obvious big circulations no matter how high or how low the opening height of the sash 25 is. And, when the opening height is getting lower, the circulations are getting bigger. In addition, because the circulations stay close to the sash 25, the harmful output may escape outside following the stirring of the circulations by mixing into them. Circulations may occur not only near the sash, they may occur near the chest of an operator. The circulations near the chest of the operator are just like those occurred after air passing through an obtuse object; and the harmful output may be mixed into the circulations to make the density of the harmful output near the chest of the operator become higher.

The problems with the above fume hoods are owing to the lack of considering the flow field structure of CFD. So, the refinements to the structure of the fume hood according to the prior art, such as the refinements to baffle, blower, sash and wall, do not benefit much to prevent circulations in the flow fields or to prevent the harmful output from leakage. These refinements may cost a lot yet the results are much in doubt. So, the prior arts do not fulfill users' requests on actual use.

### SUMMARY OF THE INVENTION

Therefore, the main purpose of the present invention is to depose an exhaust outlet with a suction slot at front rim of a bottom surface of a fume hood by which an efficient local air-suction near a contaminant source is obtained to exhaust pernicious gases while saving energy.

Another purpose of the present invention is to depose a screen on the top of the fume hood to obtain a mechanism of air suction together with air supply to quickly exhaust pernicious gases while saving energy.

To achieve the above purposes, the present invention is a downdraft fume hood, comprising a hood, a sash, an exhaust outlet, a blower and a screen. Therein, the hood has a containing space to contain pernicious gases to be exhausted, and accessible spaces at the top surface and the side surface; the sash is dynamically combined with the hood at a side with the opening height controlled; the exhaust outlet with a suction slot is deposed at the front bottom rim of the hood; the blower is deposed at an exit end of the exhaust outlet for exhausting pernicious gases; and, the screen is deposed on the top of the hood to supply air. Accordingly, a downdraft fume hood is obtained with a mechanism of air suction and air supply to save energy while locally exhausting pernicious gases near a contaminant source.

### BRIEF DESCRIPTIONS OF THE DRAWINGS

The present invention will be better understood from the following detailed description of the preferred embodiment according to the present invention, taken in con junction with the accompanying drawings, in which

FIG. 1 is a perspective view according to the present invention;

FIG. 2 is a front view according to the present invention;

FIG. 3 is a cross-sectional view according to the present

FIG. 4 is a front view according to a prior art;

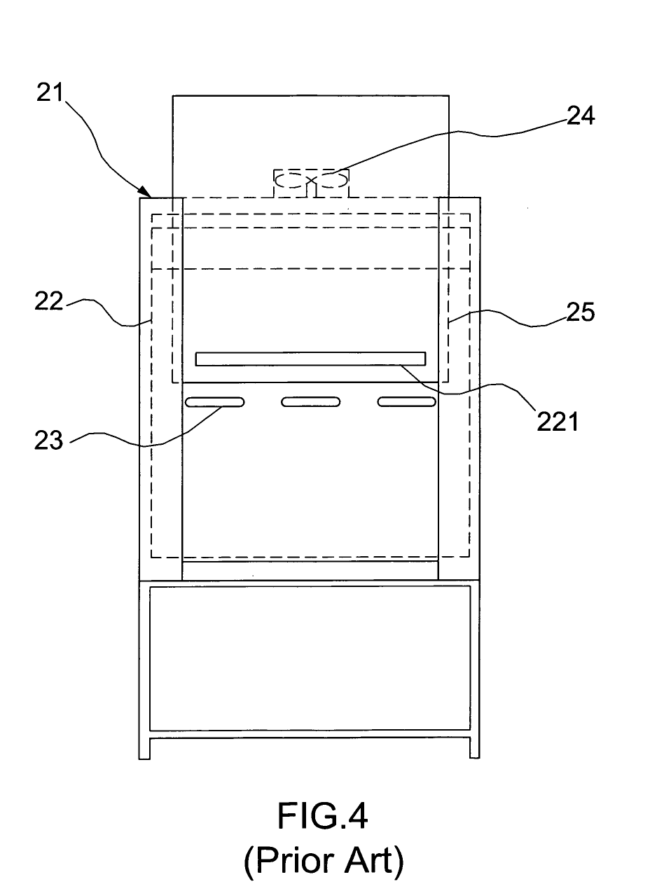

FIG. 5 is a cross-sectional view according to the prior art.

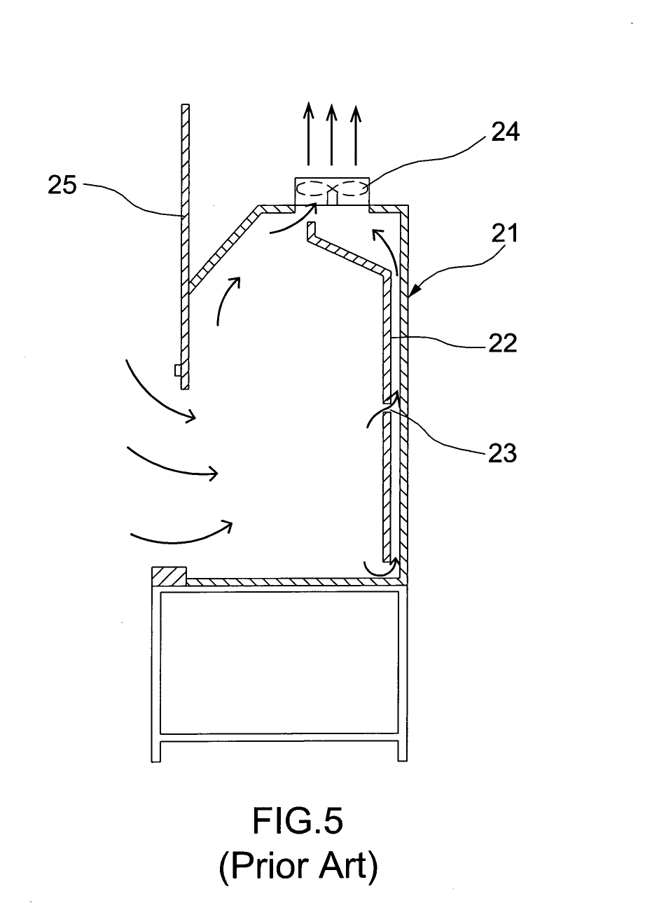

### DESCRIPTION OF THE PREFERRED EMBODIMENTS

The following description of the preferred embodiment is provided to understand the features and the structures of the present invention.

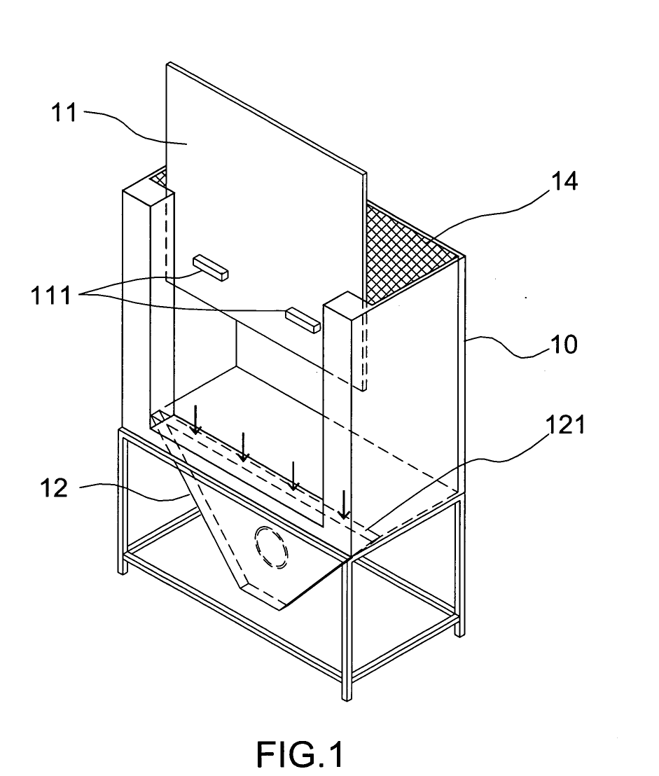

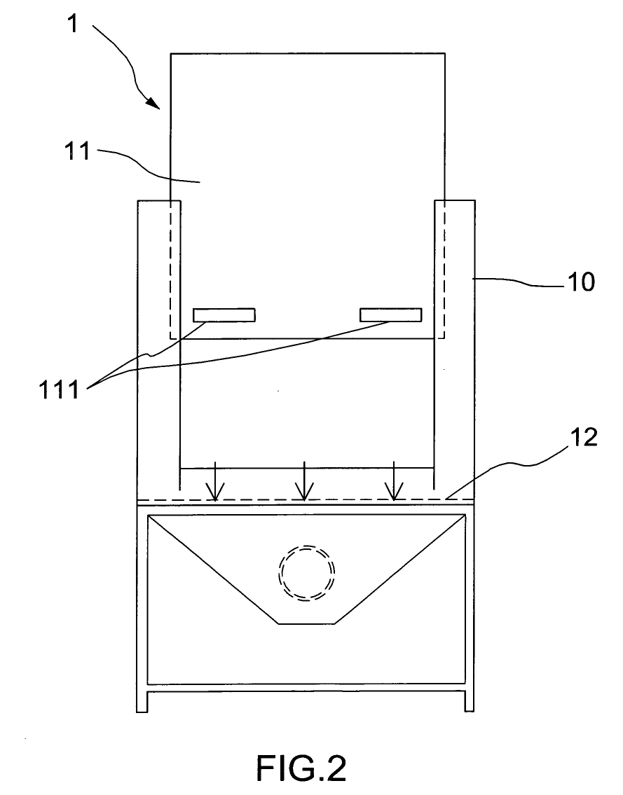

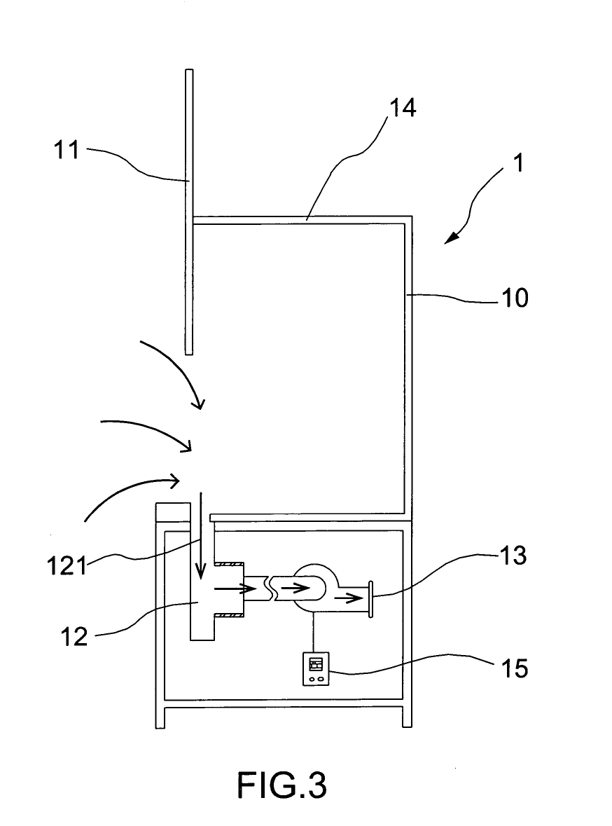

Please refer to FIG. 1 through FIG. 3, which are a perspective view, a front view and a cross-sectional view according to the present invention. As shown in the figures, the present invention is a downdraft fume hood, which comprises:

(a) a hood 10 with accessible spaces at the top surface and a side surface, having a containing space to contain pernicious gases to be exhausted;

(b) a sash 11 dynamically combined with the hood 10 at the side surface having the accessible space, the sash 11 having a handle 111 for moving the sash 11 to control the opening height of the sash 11, the sash 11 having a maximum opening height (H Max) of 60 cm (centimeter);

(c) an exhaust outlet 12 with a suction slot 121, deposed at the front rim of the bottom surface of the hood 10;

(d) a blower 13 deposed at the exit end of the exhaust outlet 12 to exhaust the pernicious gases, the blower 13 having a rotation velocity controlled by an inverter 15 to change the exhausting speed of air (Vs), an average speed of air at a sectional surface of the exhaust outlet 12 or the suction slot 121; and

(e) a screen 14 deposed at the top of the hood 10 to supply air with an area of 1.5 mm (millimeter)×1.5 mm surrounded by wires, the wire having a diameter of 0.3 millimeter.

With the above structure, a downdraft fume hood is obtained. The characteristic of the present invention is to depose the exhaust outlet 10 with the suction slot 121 at the front rim of the bottom surface of the hood 10 so that the position for the air suction is changed to a place close to the contaminant source for a better local air suction. And, by deposing the screen 14 on the top of the hood 10, the physical principle of air suction together with air supply is conformed. Hence, the downdraft fume hood obtains a mechanism of air suction together with air supply; a better local air suction at a place close to the contaminant source; energy saving and efficient pernicious gases exhausting.

On using, the flow field inside the hood 10 is described as follows:

A contaminant is simulated by putting a smoke ejector in the hood 10; and, the screen 14 is put on the top of the hood 10. When the open height of the sash is H and is equal to the maximum opening height (H/H max=1) and the exhausting downdraft speed of air (Vs) is run above 12 m/s (meter per second), almost no flow field of circulation occurs When the Vs is 9.2 m/s, the stagnancy of the contaminant occurs gradually in the hood 10 after the slowing down of the downdraft speed of air yet with no obvious flow field in the hood 10, which shows a transitional status. When the Vs is 6 m/s, some obvious but small circulations and stagnancies are found in the hood 10. As a conclusion, when the opening height of the sash is equal to the maximum opening height, the circulation can be avoided from happening when the downdraft speed of air is above 12 m/s .

When the opening height of the stash 11 is equal to three fourth or a half of the maximum opening height (H/Hmax=¾ or H/H max=½), the flow fields of the contaminant in the hood 10 is basically the same as those when the opening height of the sash 11 is equal to the maximum opening height. Yet, when the suction capability in the hood 10 is obviously insufficient, circulations in the hood 10 occur obviously. Such as, when the Vs is 1 m/s, serious stagnancies of the smoke are found in the hood 10.

Consequently, considering the above three opening height of the sash 11 (H/H max=1, H/H max=¾ and H/H max=½), when the opening height of the sash 11 is getting lower, the Vs can be slowed down to a level without forming a circulation in the hood 10; in another word, with the downdraft fume hood, the Vs is faster to avoid the circulations and stagnancies of the contaminant in the hood 10 when the opening height of the sash 11 increases.

However, when the opening height of the sash 11 is equal to one fourth of the maximum opening height, no obvious changes and circulations happen to the contaminant in the hood 10.

To sum up, the present invention can deal with circulations happened when the ceiling of a fume hood is closed and contaminants can be prevented from spreading out of the hood.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A downdraft fume hood, comprising:
(a) a hood having
(i) a containing space for a pernicious gas to be exhausted,
(ii) an accessible space at an end surface, and
(iii) another accessible space at a side surface;
(b) a screen deposed on said end surface of said hood to supply air;
(c) a sash dynamically combined with said hood at said side surface of said hood with an opening height of said sash controlled;
(d) an exhaust outlet with a suction slot deposed on another end surface of said hood; and
(e) a blower deposed at an exit end of said exhaust outlet to exhaust said pernicious gas, wherein an air suction and an air supply are obtained simultaneously to exhaust said pernicious gas.

2. The fume hood according to claim 1 wherein said sash has a handle to control said opening height by moving said sash with said handle.

3. The fume hood according to claim 1 wherein an inverter is obtained to control a rotation velocity of said blower to change an exhausting speed of air.

4. The fume hood according to claim 3, wherein said exhausting speed of air is an average speed of air at a sectional surface of said exhaust outlet.

5. The fume hood according to claim 3, wherein said exhausting speed of air is an average speed of air at a sectional surface of said suction slot.

6. The fume hood according to claim 1 wherein said screen comprises a plurality of meshes, said mesh having an area of 2.25 square millimeter surrounded by wires, said wire having a diameter smaller than 0.3 millimeter.

7. The fume hood according to claim 1, wherein a maximum opening height of said sash is 60 centimeters.
